(19) United States
(12) Patent Application Publication
(10) Pub. No.: US 2014/0136121 A1
(43) Pub. Date: May 15, 2014

(54) METHOD FOR ASSEMBLING SEQUENCED SEGMENTS

(71) Applicants: Xun Xu, Shenzhen (CN); Ye Tao, Shenzhen (CN); Zequn Zheng, Shenzhen (CN); Jun Wang, Shenzhen (CN)

(72) Inventors: Xun Xu, Shenzhen (CN); Ye Tao, Shenzhen (CN); Zequn Zheng, Shenzhen (CN); Jun Wang, Shenzhen (CN)

(73) Assignee: BGI TECH SOLUTIONS CO., LTD., Shenzhen (CN)

(21) Appl. No.: 14/130,706

(22) PCT Filed: Jul. 5, 2011
(86) PCT No.: PCT/CN2011/076840

§ 371 Date: Jan. 3, 2014

(51) Int. Cl. G06F 19/22

(52) U.S. Cl. CPC G06F 19/22
USPC 702/20

(57) ABSTRACT

The present invention relates to a method for optimizing the assembled result of sequencing data using a genetic map. In particular, provided in the present invention is a new method for assembling individual sequenced segments, which comprises the step of constructing the genetic map with a genetic marker. Furthermore, also provided in the present invention is a method for assembling the individual sequenced segments into a genome sequence, such as a chromosome sequence.

### FIELD

The present disclosure relates to fields of genetic engineering technology, genetics and bioinformatics, and more particularly to a method of optimizing an assembly result of sequencing data using a genetic map. Thus, the present disclosure provides a novel method of assembling reads of an individual, comprising a step of constructing a genetic map using genetic markers. In addition, the present disclosure also provides a method of assembling genomic sequencing data into genomic sequence, such as a chromosomal sequence.

### BACKGROUND

The Next-Generation DNA sequencing technology is a high-throughput sequencing technique with low cost, and the principle of the Next-Generation DNA sequencing technology is sequencing by synthesis. As an example, the Solexa sequencing method comprises: firstly, randomly breaking DNA double strands using a physical method; secondly, ligating a specific adaptor to an obtained DNA fragments at both ends, in which the specific adaptor comprises an amplifying primer sequence; thirdly, sequencing DNA fragments ligating the specific adaptor. During sequencing, a DNA polymerase synthesizes a complementary strand to a fragment to be tested using an adaptor, and detect a fluorescence signal carried by the newly incorporated bases to obtain a base sequence, then the sequence of the fragment to be tested may be obtained. These obtained sequences are known as reads. A basic process of the Solexa sequencing method may refer to, for example, http:/www.illumina.com.

To restore a whole sequence status of a genome (for example, assembling reads into a genomic sequence, such as a chromosome sequence), the Next-Generation sequencing method generally takes the way of connecting reads in gradients. Firstly, using an overlapping relationship between reads, the reads are extended as much as possible (i.e. connecting together), to form contigs. Secondly, using a distance relationship between both ends of the reads in a double-ended sequencing, different contigs of the reads comprising two ends are connected together by adding a certain number of N in the middle, and these fragments so formed are known as scaffolds. In each scaffold, a sequential relationship of the contigs about the N-region is already known, and a distance in the DNA sequence thereof is also known. Lastly, an information of these N-regions is restored into ATCG by means of “filling holes”. One method of “filling holes” comprises: finding a double-ended sequencing read with one end falling into a known sequence of the scaffold, and the other end falling into the N-region of the scaffold; calculating all reads falling into the N-region; and partially assembling using the overlapping relationship to obtain the sequence information of the N-region. A general process of sequence connecting may refer to, for example, Li, R. et al. De novo assembly of human genomes with massively parallel short read sequencing. Genome Res 20, 265-72 (2010).

Although a known software may be used to connect the sequencing data (i.e. reads) obtained using the Next-Generation sequencing method, a length of reads obtained using the Next-Generation sequencing method are generally shorter (generally only 100 nt). Thus, there is a certain limitation when performing data connecting: it is difficult to connect the reads to form the genomic sequence, such as the chromosome sequence, only relying on assembly software.

Thus, it is an urgent need to improve the method of assembling the sequencing data (i.e. reads), to further optimize the assembly result of the sequencing data, for example, the reads are connected into the genomic sequence, such as the chromosomal sequence.

### SUMMARY

In the present disclosure, unless otherwise stated, technical and scientific terms used herein have commonly understood meanings by those skilled in the art. And, laboratory procedures of genetics, molecular biology and nucleic acid chemistry used herein are all conventional procedures widely used in the related field. At the same time, to better understand the present disclosure, definitions and explanations of relevant terms are provided below.

As used herein, the term “genetic map” is also known as a linkage map and a chromosomal map, which shows a relative distance (i.e. a genetic distance) between genes or genetic markers, but does not show a physical distance of the genes or the genetic markers on a chromosome. In the genetic map, a position relationship between the genes and the genetic markers is described using the genetic distance, and the genetic distance is calculated using recombination rate. In general, the longer distance between two genes or genetic markers on the same chromosome, the greater probability of a recombination occurrence in the course of meiosis, the smaller probability of a common genetic. Based on a segregation of offspring characters thereof, a recombination rate thereof may be calculated, so as to calculate the genetic distance on the genetic map thereof. In the case of a recombination rate of two genes or genetic markers being 1%, the genetic distance thereof may be define as 1 cm (centimorgan).

At present, commonly-used genetic markers mainly comprise restriction fragment length polymorphism (RFLP), simple sequence repeats (SSR), sequence-tagged site (STS) and single nucleotide polymorphism (SNP). These genetic markers are all well-known to those killed in the art, which may refer to, for example, Agarwal, M., Shrivastava, N. & Padh, H. Advances in molecular marker techniques and their applications in plant sciences. Plant cell reports 27, 617-631 (2008).

As used herein, term “SNP” refers to a polymorphism of DNA sequence caused by a variation of a single nucleotide. SNP is the most common one among biological heritable variations, which accounts at least 90% of all known polymorphisms. SNP site widely exists in a genome of each species. Specifically, in human genome, averagely every 500 to 1,000 base-pairs having an SNP site, and the total number thereof may be estimated up to 3 million or more.

As used herein, term “reads” refers to sequencing data obtained using various sequencing methods to perform sequencing. For example, a Next-Generation sequencing method, such as

Solexa sequencing method is an optimized method for providing reads.

As used herein, term “scaffold” refers to fragments obtained by connecting the reads by means of an overlapping relationship and a physical distance relationship between the reads.

As used herein, expression “assembling reads into a chromosomal sequence” refers to clustering together the reads derived from an individual, and arranging them in accordance with their order or relative position on a chromosome (optionally, the reads are firstly connected into the scaffolds, and then the steps of clustering and arranging are performed), to obtain a status of the relative position of each fragment on the chromosome, and then to obtain the chromosomal sequence of the individual or a part of the chromosomal sequence thereof. Accordingly, the expression involves a process of clustering and arranging. In the case of the reads completely covering an entire chromosome, an intact chromosomal sequence may be obtained. However, if the reads cannot cover the entire chromosome, then the status of the relative position of these fragments on the chromosome may be obtained, as well as the part of the chromosomal sequence (i.e. there is a part of the chromosomal sequence still unknown, which needs to be determined by further sequencing).

As used herein, expression “assemble reads (or scaffolds)” refers to arranging each read (or scaffold) in accordance with a relationship of the relative position.

As used herein, expression “arrange” not only refers to arranging each read (or scaffold) in accordance with a relationship of the relative position, but also to determining a connecting direction of each fragments.

In the present disclosure, the inventors combine the genetic map with the assembly of the reads, to provide a novel method of assembling the sequencing data (i.e. reads), which optimizes the assembly result of the sequencing data and enables assembling the reads into the genomic sequence, such as the chromosomal sequence.

The present disclosure is at least partially based on the following principle: if the genetic distance between two genes or genetic markers is very short, such two genes or genetic markers may be then regarded as being linked. Usually, the physical distance of the two linked genes or genetic markers on a sequence is also close, and the two linked genes or genetic markers belong to a same chromosome. Thus, the linkage relationship between the genetic markers in the genetic map may be used to cluster together the reads or scaffolds, comprising a linked marker, in accordance with the chromosome, and a size relationship and a relative position between the genetic markers may be used to orderly connect the reads or the scaffolds into the chromosomal sequence, or part sequence of the chromosome.

Specifically, in the present disclosure, the inventors exemplarily construct a genetic map using SNP genetic markers. An obtained genetic map comprises a large amount of the SNP markers, and provides a linkage relationship among these SNP markers. Accordingly, based on the linkage relationship among the SNP markers in the genetic map, reads or scaffolds comprising a linked SNP marker may be clustered together in accordance with a chromosome. Further, based on a genetic distance and a relative position between the SNP markers, the reads or the scaffolds belonged to the same chromosome may be orderly arranged, to realize assembling the reads into the chromosomal sequence.

Thus, in one aspect, the present disclosure provides a method of assembling reads of an individual. The method may comprise:

constructing a genetic map using genetic markers, in which the genetic map is used to cluster and arrange the reads comprising the genetic markers, to assemble the reads;

In a preferred embodiment, optionally, prior to clustering and arranging the reads, the reads are connected into scaffolds, and then the genetic map is used to cluster and arrange the scaffolds. Methods well-known in the art may be used to connect the reads into the scaffold, for example, a Soap Denovo assembly software is used.

In a preferred embodiment, the genetic markers are SNP site markers.

In a preferred embodiment, the reads derived from a progeny population of the individual are aligned to the scaffolds of the individual, to search and determine the SNP site markers.

In a preferred embodiment, a SOAP software and a SOAPSnp software are used to search and determine the SNP site markers.

In a preferred embodiment, a Next-Generation sequencing method, such as a Solexa sequencing method, is used to sequence a genome of the individual, to obtain the reads of the individual.

In a preferred embodiment, the individual is an animal (such as mammal) or a plant (such as monocotyledon, dicotyledon and the like)

In another aspect, the present disclosure provides a method of assembling reads of an individual into a chromosomal sequence. The method may comprise:

1) providing the reads of the individual;

2) optionally, connecting the reads into scaffolds;

3) constructing a genetic map using genetic markers;

4) determining a linkage relationship between the genetic markers using a genetic distance between the genetic markers in the genetic map, to cluster together the reads or the scaffolds comprising the genetic markers in accordance with a chromosome;

5) arranging the reads or the scaffolds, belonging to a same chromosome, in a sequential order using the genetic distance between the genetic markers in the genetic map, and determining a connecting direction of each fragment, to assemble the reads into the chromosomal sequence.

In a preferred embodiment, in step 1), a Next-Generation sequencing method, for example a Solexa sequencing method, is used to sequence a genome of the individual, to provide the reads of the individual;

In a preferred embodiment, in step 2), a SOAP Denovo assembly software is used to connect the reads into the scaffolds.

In a preferred embodiment, in step 3), the used genetic markers are SNP site markers.

In a preferred embodiment, in step 3), the reads derived from a progeny population of the individual are aligned to the scaffolds of the individual, to search and determine the SNP site markers.

In a preferred embodiment, in step 3), a SOAP software and a SOAPSnp software are used to search and determine the SNP site markers.

In a preferred embodiment, at least three genetic markers are selected from each read or each scaffold for steps 4) and 5).

The linkage relationship between the genetic markers may be determined based on methods well-known in the art (See, for example, Botstein, D., White, R. L., Skolnick, M. & Davis, R. W. Construction of a genetic linkage map in man using restriction fragment length polymorphisms. American Journal of Human Genetics 32, 314 (1980)).

In a preferred embodiment, in step 4), the linkage relationship between the genetic markers is determined by following steps:

1) calculating a genetic distance between every two of all genetic markers;

2) setting a threshold value according to a distribution of all genetic distances, for example the threshold value is set as a minimum of confidence interval being 95% or less (99%) of the distribution;

wherein two genetic markers of which the genetic distance are below the threshold value are regarded as being linked and belonging to the same chromosome.

In a preferred embodiment, the same number of the genetic markers (such as at least 3) is selected from each read or each scaffold for step 4), and in step 4), the reads or the scaffolds are clustered together in accordance with the chromosome by following steps:

1) clustering together the reads or the scaffolds comprising linked genetic markers, to form linkage groups;

optionally, performing steps 2) and 3):

2) for all reads or all scaffolds which cannot be clustered together to form any linkage groups in step 1),

calculating a quadratic sum of a genetic distance of the genetic markers in each unclustered fragment and a genetic distance of the genetic markers in each fragment of all linkage groups respectively;

selecting an unclustered fragment having a minimal quadratic sum and a corresponding fragment which has been clustered into the linkage groups; and

clustering the unclustered fragment into the linkage groups the corresponding clustered fragment belonged;

3) repeating step 2), until a total genetic distance of the linkage groups reaching a genetic map total distance of species the individual belonged; in the case of the genetic map total distance of the species being unknown, clustering all scaffolds into the linkage groups.

The above-described method may realize clustering most (for example, at least 50%, at least 60%, at least 70%, at least 80%, at least 90%, at least 95%, at least 96%, at least 97%, at least 98%, at least 99%, or more) or all of the reads or the scaffolds together in accordance with the chromosome.

In a preferred embodiment, in step 5), an MSTmap software is used to arrange the genetic markers, to determine the sequential order of each scaffold comprising the genetic markers and belonging to the same chromosome.

In a preferred embodiment, the individual is an animal (such as mammal) or a plant (such as monocotyledon, dicotyledon and the like).

In another aspect, the present disclosure provides usage of a genetic marker in assembling reads of an individual.

In a preferred embodiment, the genetic markers are SNP site markers.

In a preferred embodiment, the reads of the individual are obtained by sequencing a genome of the individual using a Next-Generation sequencing method, such as a Solexa sequencing method

In a preferred embodiment, the reads of the individual are firstly connected into scaffolds, for example a SOAPDenovo assembly software is used to connect the reads into the scaffolds, and then further assembly is performed using the genetic markers;

In a preferred embodiment, the genetic markers are used to assemble the reads of the individual into a chromosomal sequence.

In a preferred embodiment, the individual is an animal (such as mammal) or a plant (such as monocotyledon, dicotyledon and the like).

General methods of constructing a genetic map using genetic markers, such as SNP, are known to those skilled in the art. (See, for example Shifman, S. et al. A high-resolution single nucleotide polymorphism genetic map of the mouse genome. PLoS biology 4, e395 (2006) and Groenen, M. A. M. et al. A high-density SNP-based linkage map of the chicken genome reveals sequence features correlated with recombination rate. Genome research 19, 510 (2009)). In the present disclosure, SNP is taken as an example, which exemplarily provides a method of constructing a genetic map.

For constructing SNP genetic map, it is usually needed to determine SNP site and calculate genetic distance (i.e. recombination rate) between each SNP site. Accordingly, a progeny population of the target individual, into which the reads are assembled, usually are firstly obtained (for example, the target individual as a parent hybridizes with a reference, and then is subjected to self-breeding, to provide the progeny population), and then the SNP site is determined and the genetic distance between each SNP site is calculated by means of such progeny population (i.e. recombination rate)

Determination of the SNP Site

Taken plant as an example, a plurality of individuals in the progeny population of the target individual, into which the reads are assembled, are sequenced. In general, a sequencing depth of each progeny individual is about 2× to 3× (i.e. the total data volume of the reads reaches to about 2-3 times) or more, to basically cover the entire genomic sequence. Thus, respective sequencing data of the plurality of progeny individuals from the target individual may be obtained (i.e. reads).

Then using, for example, a SOAP software (Li, R. et al. SOAP2: an improved ultrafast tool for short read alignment. Bioinformatics 25, 1966-7 (2009)), the reads of each progeny individual are aligned back into the parent which is obtained by connecting into the scaffolds (i.e. the target individual); and for example, a SOAPSNP software (Li, R. et al. SNP detection for massively parallel whole-genome resequencing. Genome Research 19, 1124 (2009)) is used to search a SNP site (i.e. a site comprising a difference of a single base between a parent individual and a progeny individual).

Prior to performing alignment, optionally, the reads of each progeny individual may be filtered, to remove unqualified reads in each individual. The unqualified reads include but not limited to following cases:

the base number, which a sequencing quality is below a certain threshold value (determined by specific technique and sequencing environment), exceeds 50% of the base number of all reads;

the base (i.e. N of the reads) number with uncertain sequencing result in the reads exceeds 5% of the base number of all reads;

an exogenous sequence presented in the reads (an introduced exogenous sequence by experiment, for example, except an adaptor sequence of a sample).

when performing alignment, a default parameter of a software is generally used, without an allowance of a gap existence, and the number of mismatching is not more than 5 bases. In addition, those reads which can be aligned to a plurality of sites in a genome are generally filtered out.

Furthermore, the SOAPSNP result is subjected to processing, to search those SNP sites which exist in parent but segregate in progeny. Scaffolds, which these SNP sites locate, and coordinates thereof in the scaffolds are both recorded. The process of searching and determining the SNP site is shown in FIG. 1.

Calculation of a Genetic Distance Between SNP Sites

According to the information of the SNP site of each progeny individual, a base of the SNP site in the progeny individual derived from a male parent or a female parent (i.e. genotype information) may be determined, which can further determine a distribution of the base of the SNP site in the parent individual among all progeny individuals (See FIG. 2). Thus, a recombination rates between every two SNP sites can be calculated, to obtain a genetic distance between any two SNP sites. The genetic distance is calculated using a mapping function described in Kosambi, D. The estimation of map distances from recombination values. Annals of Human Genetics 12, 172-175 (1943), in which M represents the genetic distance, r represents the recombination rate, then:

$$M = \frac{1}{4} ln ( \frac{1 + 2 r}{1 - 2 r} )$$

$$r = ( 1 - \frac{same}{total} ) / 2$$

in which, same is the number of which two bases of the SNP site derive from the same parent individual, total is the total number of the individuals.

According to the above formula, the genetic distance between every two SNP sites may be calculated, which may further construct a SNP genetic map. On this basis, a linkage relationship between every two SNP marker sites may be determined Normally, two SNP sites of which genetic distances are very close are regarded as being linked, and the physical distance thereof in the chromosome is not too far, i.e., such two SNP sites may be basically regarded as belonging to the same chromosome.

Clustering of the Scaffolds

On the basis of constructed genetic map, by means of the relative position relationship and the linkage relationship between the genetic markers in the genetic map, the scaffolds of the parent individual (target individual) may be clustered in accordance with a chromosome. An exemplary method of clustering the scaffolds in accordance with the chromosome is provided below.

In order to simply the complexity of analysis, it may not need to subject all searched SNP sites to clustering. In general, three SNP site markers may be selected from each scaffold: in which two of them locate at two ends of the scaffolds respectively (one locates at a front-end of the scaffold, and the other locates at a back-end of the scaffold), while the third SNP site marker locates in the middle of the scaffold. The genetic distances between the SNP site located in the middle of the scaffold and several SNP sites surrounding are usually not very long, and two SNP site markers located at two ends of the scaffold close to the every end of the scaffold as much as possible, and the genetic distance between these two SNP site markers is greater than zero.

The genetic distance between every two SNP sites is calculated, the total number of pairwise SNP site markers with equal genetic distance is subjected to statistics, with which a graph is plotted taken the genetic distance as X-coordinate and taken the total number of pairwise SNP site markers as Y-coordinate. Using qqplot (Wilk, M. B. & Gnanadesikan, R. Probability plotting methods for the analysis of data. Biometrika 55, 1 (1968)) function of R software, it has been found that the distribution of the above plotted graph follows Normal Distribution. An abscissa value of the distribution of which a confidence interval is at least 95% is taken as a threshold value, and two SNP site markers of which the abscissa value is less than the threshold value are regarded as belonging to the same chromosome.

Thus, if the genetic marker between two SNP site markers, which locate at different scaffolds, being less than the threshold value, then these two scaffolds are regarded as belonging to the same chromosome. Based on this, all scaffolds may be clustered, and those scaffolds clustered together are regarded as a linked group.

In some cases, there may be some scaffolds which cannot be clustered into any linkage group. In these cases, the scaffolds which cannot be clustered into any linkage group may need to be further clustered into the linkage groups. Accordingly, following method may be used for further clustering:

1) calculating a quadratic sum of a genetic distance of the genetic markers in each unclustered fragment and a genetic distance of the genetic markers in each fragment of all linkage groups respectively;

selecting an unclustered fragment having a minimal quadratic sum and a corresponding fragment which has been clustered into the linkage groups; and

clustering the unclustered fragment into the linkage groups the corresponding clustered fragment belonged;

2) repeating step 1) until a total genetic distance of the linkage groups reach genetic map total distance of species the individual belonged (if the genetic map total distance of the species being unknown, all scaffolds are clustered into the linkage groups), which may realize clustering the scaffolds, which cannot be clustered into any linkage group, into the linkage group. Thus, all scaffolds or at least most scaffolds (for example, at least 50% of the scaffolds, at least 60% of the scaffolds, at least 70% of the scaffolds, at least 80% of the scaffolds, at least 90% of the scaffolds, at least 95% of the scaffolds, at least 96% of the scaffolds, at least 97% of the scaffolds, at least 98% of the scaffolds, at least 99% of the scaffolds, or more scaffolds) of the parent individual (the target individual) may be clustered.

Sorting of the Scaffolds

After clustering the scaffolds, the genetic distance between the genetic markers (for example, the SNP site marker) may be used to sort various scaffolds belonged to the same chromosome. For example, an MSTmap software (Wu, Bhat et al. 2008) may be used to sort the SNP site marker located in the middle of the scaffold. The MSTmap software may be able to sort various scaffolds by constructing a minimum spanning tree, according to a size of the genetic distances between various genetic markers. In general, an actual sequential order of the genetic marker may be obtained by calculating a minimum spanning tree of the graph. Based on this, a relative relationship of various genetic markers, which locate in the middle of the scaffolds, in the linkage group may be obtained, which may further determine the sequential order of various scaffolds belonged to the same chromosome.

Determination of a Connected Direction of the Scaffolds

Furthermore, the genetic distance between the genetic markers (such as SNP site marker) may be used to determine a connected direction of various scaffolds.

For example, after sorting various scaffolds belonged to the same chromosome, a genetic distance between the SNP site markers located at both ends of one scaffold (front-end and back-end) and the SNP site marker located in the middle of previous scaffold, which may determine the connected direction of the one scaffold with the previous scaffold. If a genetic distance between the SNP site marker located at either end of the scaffold and the SNP site marker located in the middle of the previous scaffold is relatively close, then the very end of the one scaffold connects to the previous scaffold, which may determine the connected direction of the one scaffold. Optionally, any other suitable marker combination (for example, SNP site markers located at front-end and middle of scaffold with a pending connected direction, or SNP site markers located at back-end and in middle of scaffold with a pending connected direction, as well as any one of SNP site markers of the previous scaffold) may be used to determine the connected direction of the scaffold

After clustering and sorting the scaffolds as well as determining the connected direction (for example, according to above-mentioned steps), most scaffolds may be clustered together and then aligned to a chromosome or a certain fragment of a chromosome, so as to assemble reads into a chromosomal sequence. FIG. 3 exemplarily shows an assembly result of reads derived from a watermelon which is a species with a smaller genome (11 chromosomes) (the used assembly method is similar with the method described in Examples), in which the left side represents a genetic sequential relationship of the genetic marker, the right side represents a position relationship of the scaffold in the chromosome. Such assembly result proves the reliability and effectiveness of the method of the present disclosure, i.e. the method of the present disclosure may be used to effectively assemble the reads of the individual into the chromosomal sequence.

### Advantageous Effects of the Present Disclosure

The present disclosure innovatively combines a genetic map with reads together, to provide a novel method of assembling sequencing data (i.e., reads). Comparing with the prior art, the technical solution of the present disclosure has following advantageous effects:

1) it has been solved as a choke point that reads are unable to be assembled into a genomic sequence (such as chromosomal sequence) using a reads assembly software, which optimizes an assembly result of sequencing data;

2) it has been realized that reads are assembled into a genomic sequence, such as a chromosomal sequence, which provides a more powerful tool for genomics.

Reference and examples will be made in details to embodiments of the present disclosure, and it would be appreciated by those skilled in the art that following figures and examples are explanatory, illustrative and used to generally understand the present disclosure, but not construed to limit the present disclosure. According to following detailed descriptions of figures and preferred embodiments, various purposes and advantages of the present disclosure will become apparent to those skilled in the art.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 schematically describes a flow chart of searching SNP site using SOAP software and SOAPSnp software.

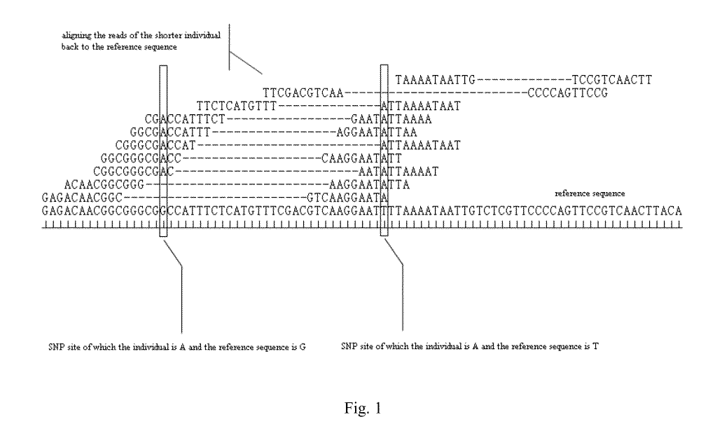

FIG. 2 schematically demonstrates a genotype information of the progeny individual, in which, a represents deriving from male parent, b represents deriving from female parent.

FIG. 3 schematically demonstrates an assembly result of reads, in which the left side represents a genetic sequential relationship of genetic markers, the right side represents a relationship of scaffolds on a chromosome.

FIG. 4 is a distribution diagram of genetic markers between SNP site markers derived from 9311 rice, in which X-coordinate represents genetic distance; Y-coordinate represents the total number of pairwise SNP site markers.

FIG. 5 schematically demonstrates a partial assembly result of reads derived from 9311 rice (i.e. a linkage group LG 09), in which, the left side represents a genetic sequential relationship of genetic markers, the right side represents a position relationship of scaffolds on a chromosome.

### DETAILED DESCRIPTION

In order to make the purpose, technical solution and advantage of the present disclosure more apparent, a further description will be described in details to the present disclosure. It would be appreciated by those skilled in the art that specific examples described herein are explanatory for the present disclosure, but not be construed to limit the present disclosure.

### Example 1

In the present example, 9311 rice was taken as an example, which exemplarily described the method of assembling reads according to the present disclosure.

Obtaining Scaffolds of 9311 Rice

The genome of 9311 rice was sequenced using Solexa sequencing platform (illumine company), to provide reads of 9311 rice. Then, using methods well-known in the art, for example Soap Denovo assembly software (http://soap.genomics.org.cn/soapdenovo.html), the reads of 9311 rice was connected into scaffolds, these sequence information of the scaffolds may refer to Yu, Hu et al. 2002.

Obtaining Progeny Population of 9311 Rice

The 9311 rice (Yu, J. et al. A draft sequence of the rice genome (Oryza sativa L. ssp. indica). Science 296, 79 (2002)) was subjected to hybridization with pa64 rice (Wei, G et al. A transcriptomic analysis of superhybrid rice LYP9 and its parents. Proc Natl Acad Sci USA 106, 7695-701 (2009)), to obtain F1 generation, and then the F1 generation self-bred for 16 generations, to obtain a progeny population of 9311 rice. 135 progeny individuals were selected randomly from the progeny population obtained from self-breeding for 16 generations, to subject to an individual sequencing having a sequencing depth of 2× (a data volume of twice genome), to provide reads of the progeny individual.

Searching and Determining SNP Site

Taking the scaffolds from the parent 9311 rice as a reference sequence, using SOAP software (Li, R. et al. SOAP2: an improved ultrafast tool for short read alignment. Bioinformatics 25, 1966-7 (2009)), the reads of the 135 progeny individuals were aligned back to the reference sequence.

Based on the aligned result obtained using SOAP software, SOAPSnp software (See, for example, http://soap.genomics.org.cn/soapsnp.html or Li, R. et al. SNP detection for massively parallel whole-genome resequencing. Genome Research. 19, 1124 (2009)) was used to search SNP site, and determine a genotype of each SNP site in progeny individual (i.e. to determine whether a base of SNP site in the progeny individual derived from the 9311 rice or the pa64 rice).

A statistical result of SNP site from the 9311 rice was shown as Table. 1

TABLE. 1
The statistical result of SNP site from the 9311 rice

| | | | percentage of |
|---|---|---|---|
| | the total | the total | scaffolds |
| | number of | length of | comprising |
| the total | scaffolds | scaffolds | SNP site |
| number of | comprising | comprising | marker in the |
| SNP site | SNP site | SNP site | whole length |
| marker | marker | marker | of genome |
| 45516 | 537 | 340306986 bp | 89.5% |

As can be seen from the statistical result in Table. 1, the SNP site marker not only had a huge number, but also had a basically uniform distribution in the entire genome. And, these SNP site markers basically covered the entire genome, so as to use in assembling the scaffolds into a genomic sequence (for example a chromosomal sequence)

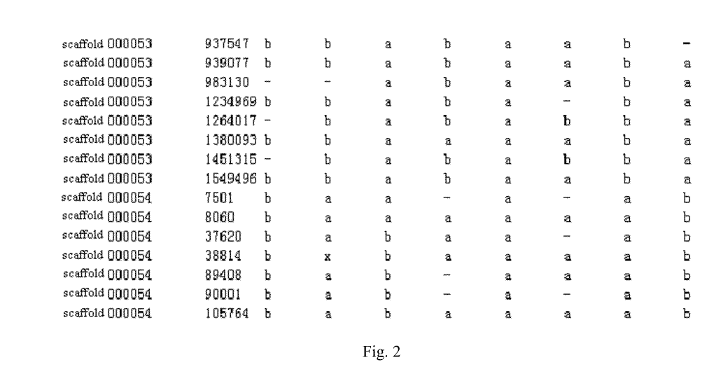

FIG. 2 demonstrated a genotype information of partial SNP sites in progeny individuals, in which a represented deriving from a male parent, b represented deriving from a female parent. Based on these genotype information, a distribution of a base of each SNP site in the progeny individuals were determined, to calculate a recombination rate between SNP site markers.

Clustering and Arranging Scaffolds

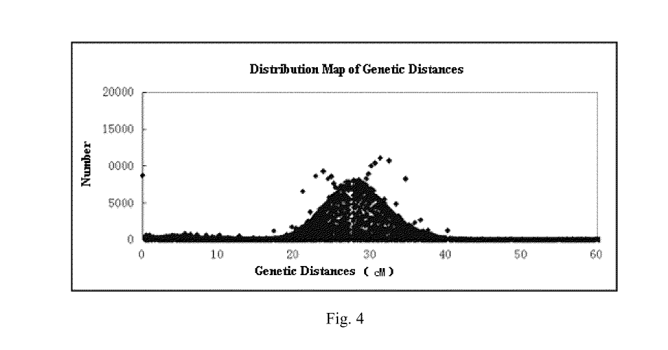

In order to clustering the scaffolds, three SNP site markers were selected out from each scaffold, in which, two of them located at two ends of the scaffolds respectively (one located at a front-end of the scaffold, and the other located at a back-end of the scaffold), while the third SNP site marker located in the middle of the scaffold. The genetic distances between every two of all selected SNP site markers were calculated. The number of the pairwise SNP site markers having the same genetic distance was subjected to statistics, with which a graph was plotted taken the genetic distance as X-coordinate and taken the number of pairwise SNP site markers as Y-coordinate (See FIG. 4).

FIG. 4 demonstrated a distribution of genetic markers between SNP site markers in 9311 rice. A qqplot function (Wilk, M. B. & Gnanadesikan, R. Probability plotting methods for the analysis of data. Biometrika 55, 1 (1968)) of R software was used to subject the distribution to a statistical test. The result showed that the distribution of the genetic distance between the SNP site markers basically followed Normal Distribution (R=0.8863972).

A 99% confidence interval of the distribution was calculated, of which a lower limit was taken as a threshold value, so as to obtain a genetic distance having a threshold value of about 3 cm. Thus, if a genetic distance between two SNP site markers being less than 3 cm, then these two SNP site markers were regarded as linked, and belonged to a same chromosome. Accordingly, the scaffolds of which these two SNP site markers located were also regarded as belonging to a same chromosome.

According to the above-described threshold value of genetic distance, all scaffolds were clustered. The results showed that, after clustering, 12 linkage groups were obtained (corresponding to the number of chromosome having a haploid in rice.

Furthermore, those scaffolds which cannot be clustered together to any linkage groups, were clustered by following steps:

1) calculating a quadratic sum of a genetic distance of SNP site marker in each unclustered scaffold with SNP site marker in various scaffolds of all linkage groups; selecting an unclustered scaffold having a minimal quadratic sum and a corresponding scaffold which has been clustered into the linkage groups; and clustering the unclustered scaffold to the linkage groups which the corresponding clustered scaffold belonged; 2) repeating step 1), until a total genetic distance of all linkage groups reached a genetic map total distance of rice species.

According to the above steps, there were total 444 scaffolds had been clustered, the total length of the scaffolds was 338,305,001 bp, which accounted for 88.2% of the genome size. And it had been realized that most scaffolds were clustered together in accordance with the chromosome.

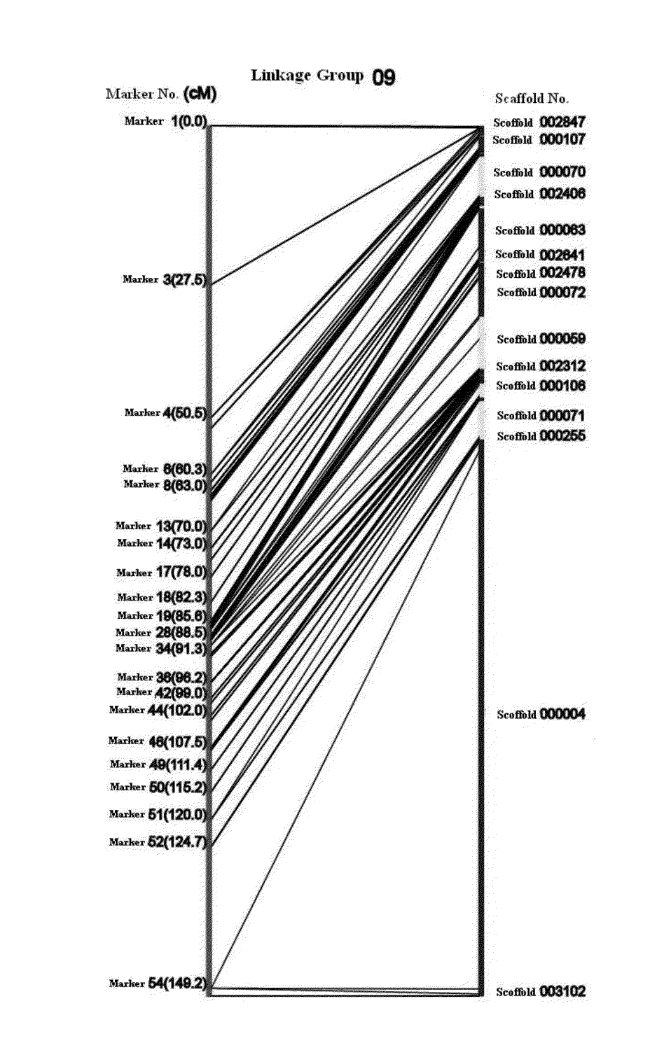

After the clustering steps were completed, an MSTmap soft (Wu, Y, Bhat, P. R., Close, T. J. & Lonardi, S. Efficient and accurate construction of genetic linkage maps from the minimum spanning tree of a graph. PLoS Genet 4, e1000212 (2008)) was used to sort the clustered scaffolds, to determine the sequential relationship thereof in the linkage groups. Then, a relative genetic distance between the SNP site marker located at both ends of various scaffolds and the SNP site marker located in the middle of the previous scaffold thereof, to determine a connected direction of various scaffolds. By the above-described assembly method, 12 linkage groups (corresponding to 12 chromosomes of the 9311 rice) were obtained, of which the detailed information had been shown in Table. 2. In addition, FIG. 5 exemplarily demonstrated an arranging situation of scaffolds in one linkage group (linkage group LG 09 of the 9311 rice, which was corresponding to chromosome 9 of the 9311 rice). To be noted, because the length of the chromosomal sequence obtained by assembling was too long, FIG. 4 only exemplarily demonstrated partial scaffolds of the linkage group LG 09, but not showed all scaffolds. However, those skilled in the art may obtain the chromosomal sequence comprising all scaffolds according to the information in Table. 2.

TABLE. 2
A statistical result of sequential order, length and connected direction of
scaffolds in 12 linkage groups of the 9311 rice.

| name of | | | | | |
|---|---|---|---|---|---|
| linkage | sequential | name of | length of | connected direction | corresponding |
| groups | order | scaffolds | scaffolds | of scaffolds | chromosome |
| LG 01 | 1 | scaffold002365 | 35,090 | forward | chromosome01 |
| LG 01 | 2 | scaffold009522 | 3,075 | forward | chromosome01 |
| LG 01 | 3 | scaffold002666 | 18,717 | reverse | chromosome01 |
| LG 01 | 4 | scaffold000417 | 22,419 | forward | chromosome01 |
| LG 01 | 5 | scaffold000165 | 58,979 | reverse | chromosome01 |
| LG 01 | 6 | scaffold000001 | 18,111,789 | forward | chromosome01 |
| LG 01 | 7 | scaffold000069 | 1,088,650 | reverse | chromosome01 |
| LG 01 | 8 | scaffold002624 | 19,409 | reverse | chromosome01 |
| LG 01 | 9 | scaffold000009 | 10,573,739 | reverse | chromosome01 |
| LG 01 | 10 | scaffold000190 | 39,777 | reverse | chromosome01 |
| LG 01 | 11 | scaffold003391 | 9,530 | forward | chromosome01 |
| LG 01 | 12 | scaffold002717 | 17,872 | forward | chromosome01 |
| LG 01 | 13 | scaffold000226 | 35,285 | forward | chromosome01 |
| LG 01 | 14 | scaffold003570 | 8,365 | forward | chromosome01 |
| LG 01 | 15 | scaffold000216 | 35,809 | reverse | chromosome01 |
| LG 01 | 16 | scaffold007201 | 3,529 | forward | chromosome01 |
| LG 01 | 17 | scaffold000020 | 5,490,501 | reverse | chromosome01 |
| LG 01 | 18 | scaffold000511 | 19,178 | reverse | chromosome01 |
| LG 01 | 19 | scaffold003404 | 9,545 | forward | chromosome01 |
| LG 01 | 20 | scaffold004156 | 6,919 | forward | chromosome01 |
| LG 01 | 21 | scaffold012513 | 1,908 | reverse | chromosome01 |
| LG 01 | 22 | scaffold002747 | 17,080 | forward | chromosome01 |
| LG 01 | 23 | scaffold002816 | 15,709 | reverse | chromosome01 |
| LG 01 | 24 | scaffold004927 | 5,479 | forward | chromosome01 |
| LG 01 | 25 | scaffold014965 | 1,297 | forward | chromosome01 |
| LG 01 | 26 | scaffold001954 | 2,990 | forward | chromosome01 |
| LG 01 | 27 | scaffold000457 | 20,981 | reverse | chromosome01 |
| LG 01 | 28 | scaffold002954 | 13,632 | forward | chromosome01 |
| LG 01 | 29 | scaffold003080 | 11,955 | forward | chromosome01 |
| LG 01 | 30 | scaffold000011 | 9,076,302 | reverse | chromosome01 |
| LG 01 | 31 | scaffold012765 | 2,169 | forward | chromosome01 |
| LG 01 | 32 | scaffold002380 | 33,420 | reverse | chromosome01 |
| LG 01 | 33 | scaffold003173 | 11,199 | reverse | chromosome01 |
| LG 01 | 34 | scaffold002415 | 29,546 | reverse | chromosome01 |
| LG 01 | 35 | scaffold000149 | 92,299 | reverse | chromosome01 |
| LG 01 | 36 | scaffold000388 | 23,633 | reverse | chromosome01 |
| LG 01 | 37 | scaffold000394 | 23,424 | forward | chromosome01 |
| LG 01 | 38 | scaffold005574 | 4,876 | forward | chromosome01 |
| LG 01 | 39 | scaffold006966 | 3,979 | forward | chromosome01 |
| LG 01 | 40 | scaffold002471 | 25,958 | reverse | chromosome01 |
| LG 01 | 41 | scaffold000409 | 22,602 | forward | chromosome01 |
| LG 01 | 42 | scaffold002310 | 44,766 | reverse | chromosome01 |
| LG 01 | 43 | scaffold001419 | 5,743 | forward | chromosome01 |
| LG 01 | 44 | scaffold000433 | 21,805 | forward | chromosome01 |
| LG 01 | 45 | scaffold000950 | 10,391 | forward | chromosome01 |
| LG 02 | 1 | scaffold000014 | 7,042,807 | forward | chromosome02 |
| LG 02 | 2 | scaffold000391 | 23,509 | forward | chromosome02 |
| LG 02 | 3 | scaffold000864 | 11,691 | forward | chromosome02 |
| LG 02 | 4 | scaffold000040 | 2,598,321 | forward | chromosome02 |
| LG 02 | 5 | scaffold000996 | 9,827 | forward | chromosome02 |
| LG 02 | 6 | scaffold000254 | 33,215 | forward | chromosome02 |
| LG 02 | 7 | scaffold002980 | 13,385 | forward | chromosome02 |
| LG 02 | 8 | scaffold002644 | 19,285 | reverse | chromosome02 |
| LG 02 | 9 | scaffold000302 | 28,827 | forward | chromosome02 |
| LG 02 | 10 | scaffold002279 | 28,540 | reverse | chromosome02 |
| LG 02 | 11 | scaffold003665 | 8,221 | forward | chromosome02 |
| LG 02 | 12 | scaffold000340 | 26,191 | forward | chromosome02 |
| LG 02 | 13 | scaffold002688 | 17,899 | forward | chromosome02 |
| LG 02 | 14 | scaffold000002 | 17,331,200 | reverse | chromosome02 |
| LG 02 | 15 | scaffold002449 | 27,340 | reverse | chromosome02 |
| LG 02 | 16 | scaffold001026 | 9,481 | reverse | chromosome02 |
| LG 02 | 17 | scaffold000356 | 25,230 | forward | chromosome02 |
| LG 02 | 18 | scaffold000303 | 28,662 | forward | chromosome02 |
| LG 02 | 19 | scaffold000246 | 33,854 | reverse | chromosome02 |
| LG 02 | 20 | scaffold000026 | 4,123,896 | reverse | chromosome02 |
| LG 02 | 21 | scaffold002785 | 16,205 | forward | chromosome02 |
| LG 02 | 22 | scaffold002292 | 51,983 | reverse | chromosome02 |
| LG 02 | 23 | scaffold000022 | 5,126,128 | forward | chromosome02 |
| LG 03 | 1 | scaffold000349 | 25,675 | forward | chromosome03 |
| LG 03 | 2 | scaffold002418 | 29,631 | reverse | chromosome03 |
| LG 03 | 3 | scaffold002763 | 16,852 | forward | chromosome03 |
| LG 03 | 4 | scaffold000913 | 10,988 | forward | chromosome03 |
| LG 03 | 5 | scaffold000027 | 3,804,194 | forward | chromosome03 |
| LG 03 | 6 | scaffold003659 | 8,205 | reverse | chromosome03 |
| LG 03 | 7 | scaffold002569 | 21,758 | reverse | chromosome03 |
| LG 03 | 8 | scaffold002778 | 16,613 | forward | chromosome03 |
| LG 03 | 9 | scaffold000085 | 553,483 | forward | chromosome03 |
| LG 03 | 10 | scaffold003242 | 10,493 | forward | chromosome03 |
| LG 03 | 11 | scaffold002275 | 78,376 | forward | chromosome03 |
| LG 03 | 12 | scaffold008308 | 3,400 | forward | chromosome03 |
| LG 03 | 13 | scaffold000505 | 19,501 | reverse | chromosome03 |
| LG 03 | 14 | scaffold000168 | 54,450 | forward | chromosome03 |
| LG 03 | 15 | scaffold002907 | 13,617 | forward | chromosome03 |
| LG 03 | 16 | scaffold003110 | 11,720 | reverse | chromosome03 |
| LG 03 | 17 | scaffold001914 | 3,144 | forward | chromosome03 |
| LG 03 | 18 | scaffold003157 | 11,285 | forward | chromosome03 |
| LG 03 | 19 | scaffold000013 | 7,064,451 | forward | chromosome03 |
| LG 03 | 20 | scaffold000019 | 5,919,547 | reverse | chromosome03 |
| LG 03 | 21 | scaffold000375 | 23,961 | forward | chromosome03 |
| LG 03 | 22 | scaffold000281 | 30,362 | forward | chromosome03 |
| LG 03 | 23 | scaffold000123 | 156,507 | forward | chromosome03 |
| LG 03 | 24 | scaffold000380 | 23,803 | forward | chromosome03 |
| LG 03 | 25 | scaffold000091 | 500,931 | forward | chromosome03 |
| LG 03 | 26 | scaffold000003 | 14,112,554 | forward | chromosome03 |
| LG 03 | 27 | scaffold000015 | 6,757,605 | reverse | chromosome03 |
| LG 03 | 28 | scaffold000265 | 32,034 | forward | chromosome03 |
| LG 04 | 1 | scaffold000016 | 6,434,379 | forward | chromosome04 |
| LG 04 | 2 | scaffold001567 | 4,903 | forward | chromosome04 |
| LG 04 | 3 | scaffold000683 | 14,989 | forward | chromosome04 |
| LG 04 | 4 | scaffold001170 | 7,791 | forward | chromosome04 |
| LG 04 | 5 | scaffold003174 | 10,348 | reverse | chromosome04 |
| LG 04 | 6 | scaffold000060 | 1,310,831 | reverse | chromosome04 |
| LG 04 | 7 | scaffold000626 | 16,282 | reverse | chromosome04 |
| LG 04 | 8 | scaffold003510 | 8,891 | forward | chromosome04 |
| LG 04 | 9 | scaffold000111 | 309,965 | forward | chromosome04 |
| LG 04 | 10 | scaffold000099 | 425,752 | forward | chromosome04 |
| LG 04 | 11 | scaffold000108 | 331,095 | forward | chromosome04 |
| LG 04 | 12 | scaffold002741 | 17,175 | forward | chromosome04 |
| LG 04 | 13 | scaffold002377 | 21,815 | forward | chromosome04 |
| LG 04 | 14 | scaffold002376 | 10,666 | reverse | chromosome04 |
| LG 04 | 15 | scaffold002728 | 17,270 | forward | chromosome04 |
| LG 04 | 16 | scaffold000081 | 626,297 | forward | chromosome04 |
| LG 04 | 17 | scaffold007442 | 3,711 | forward | chromosome04 |
| LG 04 | 18 | scaffold003666 | 8,109 | forward | chromosome04 |
| LG 04 | 19 | scaffold000224 | 35,319 | forward | chromosome04 |
| LG 04 | 20 | scaffold002796 | 16,306 | forward | chromosome04 |
| LG 04 | 21 | scaffold000166 | 57,446 | forward | chromosome04 |
| LG 04 | 22 | scaffold002927 | 14,004 | forward | chromosome04 |
| LG 04 | 23 | scaffold000031 | 3,170,253 | reverse | chromosome04 |
| LG 04 | 24 | scaffold002319 | 42,545 | forward | chromosome04 |
| LG 04 | 25 | scaffold003458 | 9,082 | reverse | chromosome04 |
| LG 04 | 26 | scaffold004211 | 6,688 | forward | chromosome04 |
| LG 04 | 27 | scaffold000055 | 1,556,420 | forward | chromosome04 |
| LG 04 | 28 | scaffold002437 | 27,999 | forward | chromosome04 |
| LG 04 | 29 | scaffold002455 | 26,970 | forward | chromosome04 |
| LG 04 | 30 | scaffold002600 | 20,569 | forward | chromosome04 |
| LG 04 | 31 | scaffold002695 | 18,201 | forward | chromosome04 |
| LG 04 | 32 | scaffold002525 | 23,814 | reverse | chromosome04 |
| LG 04 | 33 | scaffold000533 | 18,352 | reverse | chromosome04 |
| LG 04 | 34 | scaffold000078 | 811,129 | forward | chromosome04 |
| LG 04 | 35 | scaffold000342 | 26,047 | forward | chromosome04 |
| LG 04 | 36 | scaffold002432 | 27,682 | forward | chromosome04 |
| LG 04 | 37 | scaffold002352 | 36,948 | forward | chromosome04 |
| LG 04 | 38 | scaffold002677 | 18,259 | forward | chromosome04 |
| LG 04 | 39 | scaffold000090 | 513,098 | reverse | chromosome04 |
| LG 04 | 40 | scaffold002653 | 18,939 | forward | chromosome04 |
| LG 04 | 41 | scaffold004745 | 5,566 | forward | chromosome04 |
| LG 04 | 42 | scaffold003508 | 8,809 | reverse | chromosome04 |
| LG 04 | 43 | scaffold000093 | 488,138 | reverse | chromosome04 |
| LG 04 | 44 | scaffold002328 | 40,792 | forward | chromosome04 |
| LG 04 | 45 | scaffold002349 | 37,321 | forward | chromosome04 |
| LG 04 | 46 | scaffold000148 | 98,390 | forward | chromosome04 |
| LG 04 | 47 | scaffold000075 | 880,192 | reverse | chromosome04 |
| LG 04 | 48 | scaffold002396 | 31,546 | forward | chromosome04 |
| LG 04 | 49 | scaffold002618 | 20,088 | forward | chromosome04 |
| LG 04 | 50 | scaffold000539 | 18,200 | reverse | chromosome04 |
| LG 04 | 51 | scaffold000374 | 24,098 | forward | chromosome04 |
| LG 04 | 52 | scaffold000934 | 10,687 | forward | chromosome04 |
| LG 04 | 53 | scaffold000359 | 25,060 | forward | chromosome04 |
| LG 04 | 54 | scaffold000459 | 20,888 | forward | chromosome04 |
| LG 04 | 55 | scaffold002712 | 17,664 | reverse | chromosome04 |
| LG 04 | 56 | scaffold002526 | 24,010 | forward | chromosome04 |
| LG 04 | 57 | scaffold000297 | 29,077 | forward | chromosome04 |
| LG 04 | 58 | scaffold000347 | 25,686 | forward | chromosome04 |
| LG 04 | 59 | scaffold000583 | 17,240 | reverse | chromosome04 |
| LG 04 | 60 | scaffold000096 | 442,072 | forward | chromosome04 |
| LG 04 | 61 | scaffold000104 | 391,924 | forward | chromosome04 |
| LG 04 | 62 | scaffold000005 | 13,574,865 | forward | chromosome04 |
| LG 04 | 63 | scaffold000321 | 27,546 | reverse | chromosome04 |
| LG 05 | 1 | scaffold000057 | 1,418,651 | forward | chromosome05 |
| LG 05 | 2 | scaffold000121 | 160,616 | reverse | chromosome05 |
| LG 05 | 3 | scaffold000710 | 14,337 | reverse | chromosome05 |
| LG 05 | 4 | scaffold000383 | 23,761 | forward | chromosome05 |
| LG 05 | 5 | scaffold000276 | 30,719 | forward | chromosome05 |
| LG 05 | 6 | scaffold000390 | 23,570 | reverse | chromosome05 |
| LG 05 | 7 | scaffold000113 | 294,440 | reverse | chromosome05 |
| LG 05 | 8 | scaffold002897 | 14,395 | forward | chromosome05 |
| LG 05 | 9 | scaffold002277 | 70,998 | forward | chromosome05 |
| LG 05 | 10 | scaffold000170 | 53,093 | reverse | chromosome05 |
| LG 05 | 11 | scaffold000306 | 28,406 | reverse | chromosome05 |
| LG 05 | 12 | scaffold000188 | 40,249 | forward | chromosome05 |
| LG 05 | 13 | scaffold000043 | 2,387,538 | reverse | chromosome05 |
| LG 05 | 14 | scaffold001062 | 8,976 | reverse | chromosome05 |
| LG 05 | 15 | scaffold005163 | 5,240 | forward | chromosome05 |
| LG 05 | 16 | scaffold002429 | 27,661 | forward | chromosome05 |
| LG 05 | 17 | scaffold001020 | 9,534 | forward | chromosome05 |
| LG 05 | 18 | scaffold000053 | 1,700,887 | forward | chromosome05 |
| LG 05 | 19 | scaffold000088 | 532,389 | forward | chromosome05 |
| LG 05 | 20 | scaffold002814 | 15,978 | reverse | chromosome05 |
| LG 05 | 21 | scaffold000084 | 583,342 | reverse | chromosome05 |
| LG 05 | 22 | scaffold000176 | 47,342 | reverse | chromosome05 |
| LG 05 | 23 | scaffold000061 | 1,287,921 | forward | chromosome05 |
| LG 05 | 24 | scaffold000008 | 11,869,943 | forward | chromosome05 |
| LG 05 | 25 | scaffold000161 | 64,820 | reverse | chromosome05 |
| LG 05 | 26 | scaffold000307 | 28,370 | forward | chromosome05 |
| LG 05 | 27 | scaffold000411 | 22,530 | reverse | chromosome05 |
| LG 05 | 28 | scaffold000076 | 859,805 | reverse | chromosome05 |
| LG 05 | 29 | scaffold000130 | 139,717 | forward | chromosome05 |
| LG 05 | 30 | scaffold000156 | 72,785 | forward | chromosome05 |
| LG 05 | 31 | scaffold002372 | 34,049 | forward | chromosome05 |
| LG 05 | 32 | scaffold004187 | 6,832 | reverse | chromosome05 |
| LG 05 | 33 | scaffold000012 | 7,625,277 | forward | chromosome05 |
| LG 05 | 34 | scaffold000362 | 25,032 | forward | chromosome05 |
| LG 06 | 1 | scaffold002411 | 30,323 | forward | chromosome06 |
| LG 06 | 2 | scaffold006178 | 4,443 | forward | chromosome06 |
| LG 06 | 3 | scaffold000225 | 35,285 | forward | chromosome06 |
| LG 06 | 4 | scaffold002387 | 32,462 | forward | chromosome06 |
| LG 06 | 5 | scaffold002400 | 31,195 | forward | chromosome06 |
| LG 06 | 6 | scaffold003313 | 10,185 | forward | chromosome06 |
| LG 06 | 7 | scaffold002298 | 49,666 | reverse | chromosome06 |
| LG 06 | 8 | scaffold002314 | 43,555 | reverse | chromosome06 |
| LG 06 | 9 | scaffold000360 | 25,057 | forward | chromosome06 |
| LG 06 | 10 | scaffold011106 | 2,567 | forward | chromosome06 |
| LG 06 | 11 | scaffold000036 | 2,676,551 | reverse | chromosome06 |
| LG 06 | 12 | scaffold002979 | 13,093 | forward | chromosome06 |
| LG 06 | 13 | scaffold000115 | 275,107 | reverse | chromosome06 |
| LG 06 | 14 | scaffold002936 | 13,816 | reverse | chromosome06 |
| LG 06 | 15 | scaffold005295 | 5,101 | forward | chromosome06 |
| LG 06 | 16 | scaffold000041 | 2,491,508 | forward | chromosome06 |
| LG 06 | 17 | scaffold000420 | 22,376 | reverse | chromosome06 |
| LG 06 | 18 | scaffold003261 | 10,441 | forward | chromosome06 |
| LG 06 | 19 | scaffold007170 | 3,864 | reverse | chromosome06 |
| LG 06 | 20 | scaffold002457 | 27,132 | reverse | chromosome06 |
| LG 06 | 21 | scaffold004072 | 6,959 | forward | chromosome06 |
| LG 06 | 22 | scaffold002334 | 39,311 | forward | chromosome06 |
| LG 06 | 23 | scaffold002417 | 29,224 | reverse | chromosome06 |
| LG 06 | 24 | scaffold000287 | 29,960 | forward | chromosome06 |
| LG 06 | 25 | scaffold001643 | 4,450 | reverse | chromosome06 |
| LG 06 | 26 | scaffold005976 | 4,180 | forward | chromosome06 |
| LG 06 | 27 | scaffold004978 | 5,475 | forward | chromosome06 |
| LG 06 | 28 | scaffold002843 | 15,265 | forward | chromosome06 |
| LG 06 | 29 | scaffold000379 | 23,821 | reverse | chromosome06 |
| LG 06 | 30 | scaffold000044 | 2,330,599 | reverse | chromosome06 |
| LG 06 | 31 | scaffold000047 | 2,243,037 | reverse | chromosome06 |
| LG 06 | 32 | scaffold000032 | 2,952,239 | forward | chromosome06 |
| LG 06 | 33 | scaffold000466 | 20,558 | reverse | chromosome06 |
| LG 06 | 34 | scaffold001363 | 6,114 | reverse | chromosome06 |
| LG 06 | 35 | scaffold000018 | 5,962,590 | forward | chromosome06 |
| LG 06 | 36 | scaffold000796 | 12,476 | forward | chromosome06 |
| LG 07 | 1 | scaffold000007 | 12,232,608 | forward | chromosome07 |
| LG 07 | 2 | scaffold000100 | 422,751 | forward | chromosome07 |
| LG 07 | 3 | scaffold000056 | 1,491,444 | forward | chromosome07 |
| LG 07 | 4 | scaffold000038 | 2,632,557 | reverse | chromosome07 |
| LG 07 | 5 | scaffold000017 | 6,341,531 | forward | chromosome07 |
| LG 07 | 6 | scaffold000132 | 133,160 | reverse | chromosome07 |
| LG 08 | 1 | scaffold000077 | 831,649 | forward | chromosome08 |
| LG 08 | 2 | scaffold000039 | 2,622,754 | forward | chromosome08 |
| LG 08 | 3 | scaffold000052 | 1,939,947 | reverse | chromosome08 |
| LG 08 | 4 | scaffold000042 | 2,466,211 | forward | chromosome08 |
| LG 08 | 5 | scaffold002531 | 23,148 | forward | chromosome08 |
| LG 08 | 6 | scaffold000033 | 2,885,658 | forward | chromosome08 |
| LG 08 | 7 | scaffold000079 | 679,419 | reverse | chromosome08 |
| LG 08 | 8 | scaffold001056 | 9,104 | forward | chromosome08 |
| LG 08 | 9 | scaffold000006 | 12,426,518 | forward | chromosome08 |
| LG 08 | 10 | scaffold000035 | 2,789,649 | reverse | chromosome08 |
| LG 09 | 1 | scaffold002847 | 15,370 | forward | chromosome09 |
| LG 09 | 2 | scaffold000184 | 42,473 | reverse | chromosome09 |
| LG 09 | 3 | scaffold000885 | 11,343 | reverse | chromosome09 |
| LG 09 | 4 | scaffold000124 | 155,546 | forward | chromosome09 |
| LG 09 | 5 | scaffold002311 | 44,466 | forward | chromosome09 |
| LG 09 | 6 | scaffold000107 | 342,017 | reverse | chromosome09 |
| LG 09 | 7 | scaffold006214 | 4,362 | forward | chromosome09 |
| LG 09 | 8 | scaffold000183 | 42,811 | reverse | chromosome09 |
| LG 09 | 9 | scaffold000263 | 32,117 | reverse | chromosome09 |
| LG 09 | 10 | scaffold005816 | 3,889 | reverse | chromosome09 |
| LG 09 | 11 | scaffold002812 | 16,028 | forward | chromosome09 |
| LG 09 | 12 | scaffold000253 | 33,220 | reverse | chromosome09 |
| LG 09 | 13 | scaffold000070 | 1,021,785 | reverse | chromosome09 |
| LG 09 | 14 | scaffold002406 | 30,529 | reverse | chromosome09 |
| LG 09 | 15 | scaffold000211 | 36,077 | reverse | chromosome09 |
| LG 09 | 16 | scaffold004084 | 7,044 | forward | chromosome09 |
| LG 09 | 17 | scaffold002494 | 25,660 | reverse | chromosome09 |
| LG 09 | 18 | scaffold003540 | 8,725 | forward | chromosome09 |
| LG 09 | 19 | scaffold000222 | 35,399 | forward | chromosome09 |
| LG 09 | 20 | scaffold000850 | 11,820 | forward | chromosome09 |
| LG 09 | 21 | scaffold003302 | 10,138 | forward | chromosome09 |
| LG 09 | 22 | scaffold000337 | 26,355 | forward | chromosome09 |
| LG 09 | 23 | scaffold002271 | 88,941 | reverse | chromosome09 |
| LG 09 | 24 | scaffold000063 | 1,240,123 | reverse | chromosome09 |
| LG 09 | 25 | scaffold002641 | 19,323 | forward | chromosome09 |
| LG 09 | 26 | scaffold002528 | 23,662 | reverse | chromosome09 |
| LG 09 | 27 | scaffold002300 | 49,469 | reverse | chromosome09 |
| LG 09 | 28 | scaffold000645 | 15,731 | forward | chromosome09 |
| LG 09 | 29 | scaffold002915 | 14,144 | forward | chromosome09 |
| LG 09 | 30 | scaffold000110 | 310,809 | forward | chromosome09 |
| LG 09 | 31 | scaffold002478 | 25,752 | forward | chromosome09 |
| LG 09 | 32 | scaffold000072 | 940,878 | forward | chromosome09 |
| LG 09 | 33 | scaffold000059 | 1,319,559 | reverse | chromosome09 |
| LG 09 | 34 | scaffold002312 | 43,866 | forward | chromosome09 |
| LG 09 | 35 | scaffold000509 | 19,380 | forward | chromosome09 |
| LG 09 | 36 | scaffold002866 | 15,039 | forward | chromosome09 |
| LG 09 | 37 | scaffold003034 | 12,576 | forward | chromosome09 |
| LG 09 | 38 | scaffold002362 | 36,159 | forward | chromosome09 |
| LG 09 | 39 | scaffold002382 | 33,767 | reverse | chromosome09 |
| LG 09 | 40 | scaffold001327 | 6,323 | forward | chromosome09 |
| LG 09 | 41 | scaffold002586 | 20,319 | forward | chromosome09 |
| LG 09 | 42 | scaffold000357 | 25,196 | forward | chromosome09 |
| LG 09 | 43 | scaffold002422 | 28,035 | reverse | chromosome09 |
| LG 09 | 44 | scaffold003130 | 11,504 | reverse | chromosome09 |
| LG 09 | 45 | scaffold002551 | 22,471 | forward | chromosome09 |
| LG 09 | 46 | scaffold002295 | 51,718 | reverse | chromosome09 |
| LG 09 | 47 | scaffold000106 | 376,199 | forward | chromosome09 |
| LG 09 | 48 | scaffold000566 | 17,626 | forward | chromosome09 |
| LG 09 | 49 | scaffold002459 | 26,858 | forward | chromosome09 |
| LG 09 | 50 | scaffold002906 | 13,978 | forward | chromosome09 |
| LG 09 | 51 | scaffold000071 | 973,574 | reverse | chromosome09 |
| LG 09 | 52 | scaffold000255 | 33,044 | reverse | chromosome09 |
| LG 09 | 53 | scaffold002767 | 16,418 | forward | chromosome09 |
| LG 09 | 54 | scaffold000004 | 13,648,413 | reverse | chromosome09 |
| LG 09 | 55 | scaffold003102 | 11,854 | reverse | chromosome09 |
| LG 10 | 1 | scaffold000717 | 14,199 | forward | chromosome10 |
| LG 10 | 2 | scaffold000010 | 9,226,363 | forward | chromosome10 |
| LG 10 | 3 | scaffold002705 | 17,879 | reverse | chromosome10 |
| LG 10 | 4 | scaffold002758 | 16,811 | reverse | chromosome10 |
| LG 10 | 5 | scaffold000028 | 3,656,306 | reverse | chromosome10 |
| LG 10 | 6 | scaffold001106 | 8,506 | forward | chromosome10 |
| LG 10 | 7 | scaffold000339 | 26,216 | forward | chromosome10 |
| LG 10 | 8 | scaffold000080 | 672,175 | forward | chromosome10 |
| LG 10 | 9 | scaffold000145 | 102,966 | forward | chromosome10 |
| LG 10 | 10 | scaffold002395 | 31,863 | forward | chromosome10 |
| LG 10 | 11 | scaffold004664 | 5,863 | forward | chromosome10 |
| LG 10 | 12 | scaffold003373 | 9,680 | forward | chromosome10 |
| LG 10 | 13 | scaffold000049 | 2,054,425 | forward | chromosome10 |
| LG 10 | 14 | scaffold000058 | 1,347,837 | forward | chromosome10 |
| LG 10 | 15 | scaffold000102 | 400,512 | forward | chromosome10 |
| LG 10 | 16 | scaffold003073 | 12,190 | forward | chromosome10 |
| LG 10 | 17 | scaffold000452 | 21,217 | reverse | chromosome10 |
| LG 10 | 18 | scaffold002835 | 15,590 | reverse | chromosome10 |
| LG 10 | 19 | scaffold002981 | 13,038 | forward | chromosome10 |
| LG 10 | 20 | scaffold003576 | 8,539 | forward | chromosome10 |
| LG 10 | 21 | scaffold003450 | 9,210 | reverse | chromosome10 |
| LG 10 | 22 | scaffold002817 | 15,617 | reverse | chromosome10 |
| LG 10 | 23 | scaffold002324 | 41,841 | reverse | chromosome10 |
| LG 10 | 24 | scaffold003147 | 10,991 | forward | chromosome10 |
| LG 10 | 25 | scaffold003582 | 8,574 | reverse | chromosome10 |
| LG 10 | 26 | scaffold000491 | 19,946 | reverse | chromosome10 |
| LG 10 | 27 | scaffold002648 | 19,119 | reverse | chromosome10 |
| LG 10 | 28 | scaffold000363 | 24,778 | reverse | chromosome10 |
| LG 10 | 29 | scaffold003542 | 8,354 | reverse | chromosome10 |
| LG 10 | 30 | scaffold002583 | 21,076 | reverse | chromosome10 |
| LG 10 | 31 | scaffold002398 | 31,519 | reverse | chromosome10 |
| LG 10 | 32 | scaffold003199 | 10,621 | forward | chromosome10 |
| LG 10 | 33 | scaffold002689 | 18,331 | forward | chromosome10 |
| LG 10 | 34 | scaffold000144 | 107,923 | forward | chromosome10 |
| LG 10 | 35 | scaffold002608 | 20,302 | forward | chromosome10 |
| LG 10 | 36 | scaffold000298 | 29,061 | forward | chromosome10 |
| LG 10 | 37 | scaffold004965 | 5,412 | forward | chromosome10 |
| LG 10 | 38 | scaffold002392 | 32,130 | reverse | chromosome10 |
| LG 10 | 39 | scaffold002651 | 19,089 | reverse | chromosome10 |
| LG 10 | 40 | scaffold000249 | 33,577 | forward | chromosome10 |
| LG 10 | 41 | scaffold000261 | 32,352 | reverse | chromosome10 |
| LG 10 | 42 | scaffold000098 | 436,095 | reverse | chromosome10 |
| LG 10 | 43 | scaffold014653 | 1,471 | forward | chromosome10 |
| LG 10 | 44 | scaffold007570 | 3,601 | forward | chromosome10 |
| LG 10 | 45 | scaffold002480 | 26,032 | reverse | chromosome10 |
| LG 10 | 46 | scaffold000159 | 70,207 | reverse | chromosome10 |
| LG 10 | 47 | scaffold000037 | 2,649,063 | forward | chromosome10 |
| LG 10 | 48 | scaffold000352 | 25,549 | forward | chromosome10 |
| LG 11 | 1 | scaffold000024 | 4,558,429 | forward | chromosome11 |
| LG 11 | 2 | scaffold000064 | 1,206,036 | reverse | chromosome11 |
| LG 11 | 3 | scaffold000177 | 47,109 | forward | chromosome11 |
| LG 11 | 4 | scaffold000082 | 611,242 | reverse | chromosome11 |
| LG 11 | 5 | scaffold000101 | 419,278 | forward | chromosome11 |
| LG 11 | 6 | scaffold002369 | 33,986 | forward | chromosome11 |
| LG 11 | 7 | scaffold000087 | 539,582 | reverse | chromosome11 |
| LG 11 | 8 | scaffold000089 | 524,755 | forward | chromosome11 |
| LG 11 | 9 | scaffold000147 | 99,912 | forward | chromosome11 |
| LG 11 | 10 | scaffold000095 | 462,442 | forward | chromosome11 |
| LG 11 | 11 | scaffold000455 | 21,057 | reverse | chromosome11 |
| LG 11 | 12 | scaffold000023 | 4,580,783 | reverse | chromosome11 |
| LG 11 | 13 | scaffold000074 | 905,087 | reverse | chromosome11 |
| LG 11 | 14 | scaffold000065 | 1,195,813 | reverse | chromosome11 |
| LG 11 | 15 | scaffold003053 | 12,118 | reverse | chromosome11 |
| LG 11 | 16 | scaffold002804 | 15,900 | forward | chromosome11 |
| LG 11 | 17 | scaffold002479 | 25,567 | forward | chromosome11 |
| LG 11 | 18 | scaffold004907 | 5,549 | forward | chromosome11 |
| LG 11 | 19 | scaffold002374 | 34,063 | reverse | chromosome11 |
| LG 11 | 20 | scaffold000030 | 3,198,014 | reverse | chromosome11 |
| LG 11 | 21 | scaffold000437 | 21,566 | reverse | chromosome11 |
| LG 11 | 22 | scaffold000051 | 1,959,494 | forward | chromosome11 |
| LG 11 | 23 | scaffold000610 | 16,727 | forward | chromosome11 |
| LG 12 | 1 | scaffold000135 | 125,195 | forward | chromosome12 |
| LG 12 | 2 | scaffold000092 | 490,349 | forward | chromosome12 |
| LG 12 | 3 | scaffold000086 | 549,244 | forward | chromosome12 |
| LG 12 | 4 | scaffold002268 | 122,910 | forward | chromosome12 |
| LG 12 | 5 | scaffold002304 | 47,478 | forward | chromosome12 |
| LG 12 | 6 | scaffold002278 | 68,340 | reverse | chromosome12 |
| LG 12 | 7 | scaffold000021 | 5,247,386 | reverse | chromosome12 |
| LG 12 | 8 | scaffold000229 | 35,107 | forward | chromosome12 |
| LG 12 | 9 | scaffold002353 | 36,841 | forward | chromosome12 |
| LG 12 | 10 | scaffold002895 | 14,478 | reverse | chromosome12 |
| LG 12 | 11 | scaffold002430 | 28,447 | forward | chromosome12 |
| LG 12 | 12 | scaffold002956 | 13,651 | forward | chromosome12 |
| LG 12 | 13 | scaffold000046 | 2,288,301 | forward | chromosome12 |
| LG 12 | 14 | scaffold000274 | 30,957 | reverse | chromosome12 |
| LG 12 | 15 | scaffold002559 | 22,143 | forward | chromosome12 |
| LG 12 | 16 | scaffold003569 | 8,623 | reverse | chromosome12 |
| LG 12 | 17 | scaffold000062 | 1,240,444 | forward | chromosome12 |
| LG 12 | 18 | scaffold000218 | 35,631 | forward | chromosome12 |
| LG 12 | 19 | scaffold000197 | 37,784 | forward | chromosome12 |
| LG 12 | 20 | scaffold000670 | 15,190 | forward | chromosome12 |
| LG 12 | 21 | scaffold002307 | 46,441 | reverse | chromosome12 |
| LG 12 | 22 | scaffold002787 | 15,725 | reverse | chromosome12 |
| LG 12 | 23 | scaffold002572 | 21,261 | forward | chromosome12 |
| LG 12 | 24 | scaffold000678 | 15,037 | forward | chromosome12 |
| LG 12 | 25 | scaffold000169 | 53,110 | reverse | chromosome12 |
| LG 12 | 26 | scaffold000120 | 166,455 | reverse | chromosome12 |
| LG 12 | 27 | scaffold000127 | 147,478 | reverse | chromosome12 |
| LG 12 | 28 | scaffold002486 | 25,542 | forward | chromosome12 |
| LG 12 | 29 | scaffold000122 | 159,240 | reverse | chromosome12 |
| LG 12 | 30 | scaffold003007 | 12,920 | forward | chromosome12 |
| LG 12 | 31 | scaffold002928 | 14,029 | forward | chromosome12 |
| LG 12 | 32 | scaffold002930 | 14,039 | forward | chromosome12 |
| LG 12 | 33 | scaffold000054 | 1,669,303 | reverse | chromosome12 |
| LG 12 | 34 | scaffold002383 | 33,364 | forward | chromosome12 |
| LG 12 | 35 | scaffold000116 | 260,792 | forward | chromosome12 |
| LG 12 | 36 | scaffold000327 | 27,154 | forward | chromosome12 |
| LG 12 | 37 | scaffold002296 | 50,534 | reverse | chromosome12 |
| LG 12 | 38 | scaffold003085 | 11,754 | forward | chromosome12 |
| LG 12 | 39 | scaffold002359 | 36,344 | reverse | chromosome12 |
| LG 12 | 40 | scaffold002851 | 14,984 | reverse | chromosome12 |
| LG 12 | 41 | scaffold001243 | 7,074 | forward | chromosome12 |
| LG 12 | 42 | scaffold000240 | 34,369 | reverse | chromosome12 |
| LG 12 | 43 | scaffold002614 | 20,172 | reverse | chromosome12 |
| LG 12 | 44 | scaffold002680 | 18,217 | forward | chromosome12 |
| LG 12 | 45 | scaffold002879 | 14,774 | forward | chromosome12 |
| LG 12 | 46 | scaffold002370 | 34,604 | reverse | chromosome12 |
| LG 12 | 47 | scaffold002339 | 38,759 | reverse | chromosome12 |
| LG 12 | 48 | scaffold000126 | 148,970 | reverse | chromosome12 |
| LG 12 | 49 | scaffold000343 | 25,930 | forward | chromosome12 |
| LG 12 | 50 | scaffold002485 | 25,639 | forward | chromosome12 |
| LG 12 | 51 | scaffold002589 | 21,049 | forward | chromosome12 |
| LG 12 | 52 | scaffold002623 | 19,905 | forward | chromosome12 |
| LG 12 | 53 | scaffold000097 | 436,197 | reverse | chromosome12 |
| LG 12 | 54 | scaffold003636 | 7,754 | reverse | chromosome12 |
| LG 12 | 55 | scaffold000251 | 33,310 | reverse | chromosome12 |
| LG 12 | 56 | scaffold002424 | 28,152 | reverse | chromosome12 |
| LG 12 | 57 | scaffold000322 | 27,531 | reverse | chromosome12 |
| LG 12 | 58 | scaffold002818 | 15,491 | forward | chromosome12 |
| LG 12 | 59 | scaffold004368 | 6,406 | forward | chromosome12 |
| LG 12 | 60 | scaffold002342 | 38,432 | reverse | chromosome12 |
| LG 12 | 61 | scaffold003369 | 9,718 | forward | chromosome12 |
| LG 12 | 62 | scaffold004674 | 5,794 | forward | chromosome12 |
| LG 12 | 63 | scaffold002274 | 78,498 | reverse | chromosome12 |
| LG 12 | 64 | scaffold000131 | 139,459 | forward | chromosome12 |
| LG 12 | 65 | scaffold000066 | 1,188,804 | reverse | chromosome12 |
| LG 12 | 66 | scaffold000048 | 2,107,733 | reverse | chromosome12 |
| LG 12 | 67 | scaffold002378 | 33,507 | forward | chromosome12 |
| LG 12 | 68 | scaffold002815 | 15,332 | forward | chromosome12 |
| LG 12 | 69 | scaffold002654 | 17,840 | forward | chromosome12 |
| LG 12 | 70 | scaffold002281 | 64,592 | forward | chromosome12 |
| LG 12 | 71 | scaffold003126 | 11,466 | forward | chromosome12 |
| LG 12 | 72 | scaffold000025 | 4,281,268 | reverse | chromosome12 |
| LG 12 | 73 | scaffold000105 | 390,192 | reverse | chromosome12 |

As can be seen from the above result, the method of the present example using a genetic map comprising SNP site marker, broke through the choke point that the Next-Generation sequencing technique-based assembly software cannot connect reads into chromosomal sequence, and successfully realized connecting the reads of the 9311 rice genome into the chromosomal sequence, which provided a more powerful tool for the genomics.

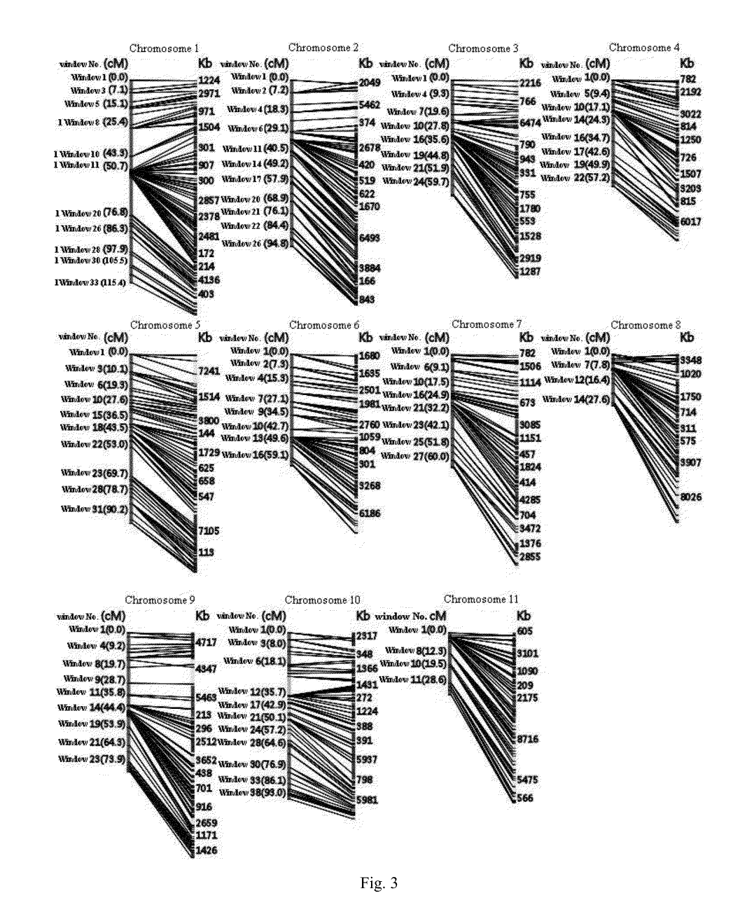

In addition, the above-describe method was also used to assemble the reads of individual derived from watermelon which is a species with a smaller genome (11 chromosomes). The assembly result of such individual reads was shown in FIG. 3, in which the left side represented the genetic sequential relationship of the genetic markers, the right side represented the position relationship of the scaffolds in the chromosome. This assembly result further proved the reliable and effectiveness of the method of the present disclosure, i.e., the method of the present disclosure may be used to effectively assemble the individual reads into the chromosomal sequence.

Although specific embodiments of the present disclosure have been described in details, the above embodiments cannot be construed to limit the present disclosure. And, it would be appreciated by those skilled in the art that various modification and changes can be made in the embodiments according to all teachings which has been already disclosed, which are all within the scope of the present disclosure. The full scope of the present disclosure is given by the claims and any equivalents thereof.

In the present text, additional details of publications and other materials for illustrating the present disclosure or providing implement of the present disclosure are all incorporated herein by reference, and following references are provided for convenience.

1. Kosambi, D. (1944). “The estimation of map distances from recombination values.” Ann. Eugen. 12: 172-175.

2. Li, R., Y. Li, et al. (2009). “SNP detection for massively parallel whole-genome resequencing.” Genome Research 19(6): 1124.

3. Li, R., Y. Li, et al. (2008). “SOAP: short oligonucleotide alignment program.” Bioinformatics 24(5): 713.

4. Li, R., H. Zhu, et al. (2010). “De novo assembly of human genomes with massively parallel short read sequencing.” Genome Research 20(2): 265.

5. Wu, Y., P. R. Bhat, et al. (2008). “Efficient and Accurate Construction of Genetic Linkage Maps from the Minimum Spanning Tree of a Graph.” PLoS Genet 4(10): e1000212.

6. Yu, J., S. Hu, et al. (2002).“A draft sequence of the rice genome (Oryza sativa L. ssp. indica).” Science 296 (5565): 79.

7. Li, R. et al. De novo assembly of human genomes with massively parallel short read sequencing. Genome Res 20, 265-72 (2010).

8. Agarwal, M., Shrivastava, N. & Padh, H. Advances in molecular marker techniques and their applications in plant sciences. Plant cell reports 27, 617-631 (2008).

9. Botstein, D., White, R.L., Skolnick, M. & Davis, R. W. Construction of a genetic linkage map in man using restriction fragment length polymorphisms. American Journal of Human Genetics 32, 314 (1980).

10. Shifman, S. et al. A high-resolution single nucleotide polymorphism genetic map of the mouse genome. PLoS biology 4, e395 (2006).

11. Groenen, M. A. M. et al. A high-density SNP-based linkage map of the chicken genome reveals sequence features correlated with recombination rate. Genome research 19, 510 (2009).

12. Li, R. et al. SOAP2: an improved ultrafast tool for short read alignment. Bioinformatics 25, 1966-7 (2009).

13. Li, R. et al. SNP detection for massively parallel whole-genome resequencing. Genome Research 19, 1124 (2009).

14. Kosambi, D. The estimation of map distances from recombination values. Annals of Human Genetics 12, 172-175 (1943).

15. Wilk, M. B. & Gnanadesikan, R. Probability plotting methods for the analysis for the analysis of data. Biometrika 55, 1 (1968).

16. Wu, Y., Bhat, P. R., Close, T. J. & Lonardi, S. Efficient and accurate construction of genetic linkage maps from the minimum spanning tree of a graph. PLoS Genet 4, el000212 (2008).

17. Wei, G et al. A transcriptomic analysis of superhybrid rice LYP9 and its parents. Proc Natl Acad Sci USA 106, 7695-701 (2009).

What is claimed is:

1. A method of assembling reads of an individual, comprising:
constructing a genetic map using genetic markers, wherein the genetic map is used to cluster and arrange the reads comprising the genetic markers, to assemble the reads;
wherein
optionally, prior to clustering and arranging the reads, the reads are connected into scaffolds, for example a Soap Denovo assembly software is used to connect the reads into the scaffolds;
for example, the genetic markers may be SNP site markers;
for example, the reads derived from a progeny population of the individual may be aligned to the scaffolds of the individual, to search and determine the SNP site markers;
for example, a SOAP software and a SOAPSnp software may be used to search and determine the SNP site markers;
for example, a Next-Generation sequencing method, such as a Solexa sequencing method, may be used to sequence a genome of the individual, to obtain the reads of the individual;
for example, the individual may be an animal (such as mammal) or a plant (such as monocotyledon, dicotyledon and the like).

2. A method of assembling reads of an individual into a chromosomal sequence, comprising:
1) providing the reads of the individual;
2) optionally, connecting the reads into scaffolds;
3) constructing a genetic map using genetic markers;
4) determining a linkage relationship between the genetic markers using a genetic distance between the genetic markers in the genetic map, to cluster together the reads or the scaffolds comprising the genetic markers in accordance with a chromosome;
5) arranging the reads or the scaffolds, belonging to a same chromosome, in a sequential order using the genetic distance between the genetic markers in the genetic map, and determining a connecting direction of each fragment, to assemble the reads into the chromosomal sequence.

3. The method of claim 2, wherein
for example, in step 1), a Next-Generation sequencing method, for example a Solexa sequencing method, may be used to sequence a genome of the individual, to provide the reads of the individual;
for example, in step 2), a SOAP Denovo assembly software may be used to connect the reads into the scaffolds.

4. The method of claim 2, wherein
for example, in step 3), the used genetic markers may be SNP site markers;
for example, in step 3), the reads derived from a progeny population of the individual may be aligned to the scaffolds of the individual, to search and determine the SNP site markers;
for example, in step 3), a SOAP software and a SOAPSnp software may be used to search and determine the SNP site markers;
for example, at least three genetic markers may be selected from each read or each scaffold for steps 4) and 5).

5. The method of claim 2, wherein
for example, in step 4), the linkage relationship between the genetic markers may be determined by following steps:
a) calculating a genetic distance between every two of all genetic markers;
b) setting a threshold value according to a distribution of all genetic distances, for example the threshold value is set as a minimum of confidence interval being 95% or less (99%) of the distribution;
wherein two genetic markers of which the genetic distance are below the threshold value are regarded as being linked and belonging to the same chromosome.

6. The method of claim 2, wherein
for example, the same number of the genetic markers (such as at least 3) is selected from each read or each scaffold for step 4), and in step 4), the reads or the scaffolds may be clustered together in accordance with the chromosome by following steps:
A) clustering together the reads or the scaffolds comprising linked genetic markers, to form linkage groups;
optionally, performing steps B) and C):
B) for all reads or all scaffolds which cannot be clustered together to any linkage groups in step A),
calculating a quadratic sum of a genetic distance of the genetic markers in each unclustered fragment and a genetic distance of the genetic markers in each fragment of all linkage groups respectively;
selecting an unclustered fragment having a minimal quadratic sum and a corresponding fragment which has been clustered into the linkage groups; and
clustering the unclustered fragment to the linkage groups which the corresponding clustered fragment belonged;
C) repeating step B), until a total genetic distance of the linkage groups reach genetic map total distance of species the individual belonged; in the case of the genetic map total distance of the species being unknown, clustering all scaffolds into the linkage groups.

7. The method of claim 6, wherein
at least 50% of the reads or the scaffolds, at least 60% of the reads or the scaffolds, at least 70% of the reads or the scaffolds, at least 80% of the reads or the scaffolds, at least 90% of the reads or the scaffolds, at least 95% of the reads or the scaffolds, at least 96% of the reads or the scaffolds, at least 97% of the reads or the scaffolds, at least of 98% of the reads or the scaffolds, at least of 99% of the reads or the scaffolds, or more reads or scaffolds may be clustered together in accordance with the chromosome.

8. The method of claim 2, wherein
for example, in step 5), an MSTmap software may be used to arrange the genetic markers, to determine the sequential order of each scaffold comprising the genetic markers and belonging to the same chromosome;
for example, the individual may be an animal (such as mammal) or a plant (such as monocotyledon, dicotyledon and the like).

9. Usage of a genetic marker in assembling reads of an individual, wherein
for example, the genetic markers may be SNP site markers;
for example, the reads of the individual may be obtained by sequencing a genome of the individual using a Next-Generation sequencing method, such as a Solexa sequencing method;
for example, the reads of the individual may be firstly connected into scaffolds, for example a SOAPDenovo assembly software may be used to connect the reads into the scaffolds, and then further assembly is performed using the genetic markers;
for example, the genetic markers may be used to assemble the reads of the individual into a chromosomal sequence;
for example, the individual may be an animal (such as mammal) or a plant (such as monocotyledon, dicotyledon and the like).
